(19) United States
(12) Patent Application Publication
(10) Pub. No.: US 2013/0163242 A1
(43) Pub. Date: Jun. 27, 2013

(54) PROTECTIVE COVER AND LAMP MODULE THEREWITH

(71) Applicants: Wintek (China) Technology Ltd., Dongguan City (CN); WINTEK CORPORATION, Taichung City (TW)

(72) Inventors: Chin-Liang Chen, Taichung City (TW); Zhi-Ting Ye, Miaoli County (TW); Ming-Chuan Lin, Taichung City (TW)

(73) Assignees: WINTEK CORPORATION, Taichung City (TW); WINTEK (CHINA) TECHNOLOGY LTD., Dongguan City (CN)

(21) Appl. No.: 13/705,145

(22) Filed: Dec. 4, 2012

(30) Foreign Application Priority Data
Dec. 21, 2011 (TW) 100147722

(51) Int. Cl. F21V 15/01

(52) U.S. Cl. CPC F21V 15/011
USPC 362/235; 362/362; 362/373

(57) ABSTRACT

A protective cover for covering a lamp base assembly of a lamp module is disclosed. The lamp base assembly is adapted for driving the lamp module. The protective cover includes a first housing and a second housing. The first housing includes a first engaging portion and the second housing includes a second engaging portion corresponding to the first engaging portion. When the second engaging portion engages with the first engaging portion, the first housing contains the lamp base assembly cooperatively with the second housing, and a surface of the lamp base assembly respectively is separated from a surface of the first housing and a surface of the second housing by a distance.

### BACKGROUND OF THE INVENTION

1. Field of the Invention

The present invention relates to a protective cover and a lamp module therewith, and more particularly, to a protective cover for containing a lamp base assembly and a lamp module therewith.

2. Description of the Prior Art

Since a light emitting diode generates heat as illuminating, a conventional design for heat dissipation is to utilize a heat dissipating module connected to the light emitting diode, so as to dissipate the heat generated by the light emitting diode as being illuminating. However, long-time use of the light emitting diode may raise the temperature of the heat dissipating module much higher. When the light emitting diode is implemented in products for indoor illumination, such as a desk lamp, an aquarium lamp and so on, it can be risky for a user to get burned due to careless touch of the exposed overheated heat dissipating module when replacing the lamp of the above-mentioned products.

Furthermore, a lamp base module of a conventional lamp with the light emitting diode is equipped with an exposed driving module, such as an AC/DC converter. When the conventional lamp with the light emitting diode is installed onto a lamp holder, the driving module is embedded inside the lamp holder for the sake of aesthetic feeling, resulting in difficulty in assembly. Moreover, some driving modules are incapable of being installed onto the lamp holder in an exposed manner.

### SUMMARY OF THE INVENTION

The present invention provides a protective cover for solving above drawbacks.

The present invention provides a protective cover for covering a lamp base assembly of a lamp module. The lamp base assembly is adapted for actuating the lamp module. The protective cover includes a first housing and a second housing. The first housing includes a first engaging portion. The second housing includes a second engaging portion corresponding to the first engaging portion. The first housing contains the lamp base assembly cooperatively with the second housing and a surface of the lamp base assembly is respectively separated from a surface of the first housing and a surface of the second housing by a distance when the second engaging portion engages with the first engaging portion.

The present invention further provides a lamp module. The lamp module includes a light guide member, a light emitting unit, a lamp base assembly and a protective cover. The light guide member has a first end and a second end opposite to the first end. The light emitting unit is disposed on at least one of the first end and the second end of the light guide member. The lamp base assembly is coupled to the light emitting unit and adapted for actuating the light emitting unit to illuminate. The protective cover includes a first housing and a second housing. The first housing includes a first engaging portion. The second housing includes a second engaging portion corresponding to the first engaging portion. The first housing contains the lamp base assembly cooperatively with the second housing and a surface of the lamp base assembly is respectively separated from a surface of the first housing and a surface of the second housing by a distance when the second engaging portion engages with the first engaging portion.

In summary, the present invention utilizes the first housing and the second housing to cooperatively contain the lamp base assembly, so as to contain the exposed components of the lamp base assembly. Accordingly, it can facilitate assembly process of a lamp holder. The protective cover can be detached in advance for a lamp of the lamp module to be installed inside the lamp holder, so as to facilitate assembly process. As a result, the detachable protective cover can meet user's requirements depending on practical demands, such that the lamp module is capable of being installed onto various lamp holders conveniently. Furthermore, the surface of the lamp base assembly is respectively separated from the surface of the first housing and the surface of the second housing by the distance, so as to prevent the user from touching the lamp base assembly directly. As a result, the present invention can prevent the user from getting burned by preventing the user from touching the lamp base assembly directly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a lamp module according to an embodiment of the present invention.

FIG. 2 is an exploded diagram of the lamp module according to the embodiment of the present invention.

FIG. 3 is a diagram of a protective cover according to the embodiment of the present invention.

FIG. 4 is an exploded diagram of the protective cover in FIG. 3.

FIG. 5 is an exploded diagram of the protective cover in FIG. 4 in another view.

FIG. 6 is a top view of a heat dissipating member according to the embodiment of the present invention.

FIG. 7 is a partly sectional diagram of the lamp module according to the embodiment of the present invention.

FIG. 8 is a sectional diagram of the protective cover taken along a section line X-X shown in FIG. 3.

### DETAILED DESCRIPTION

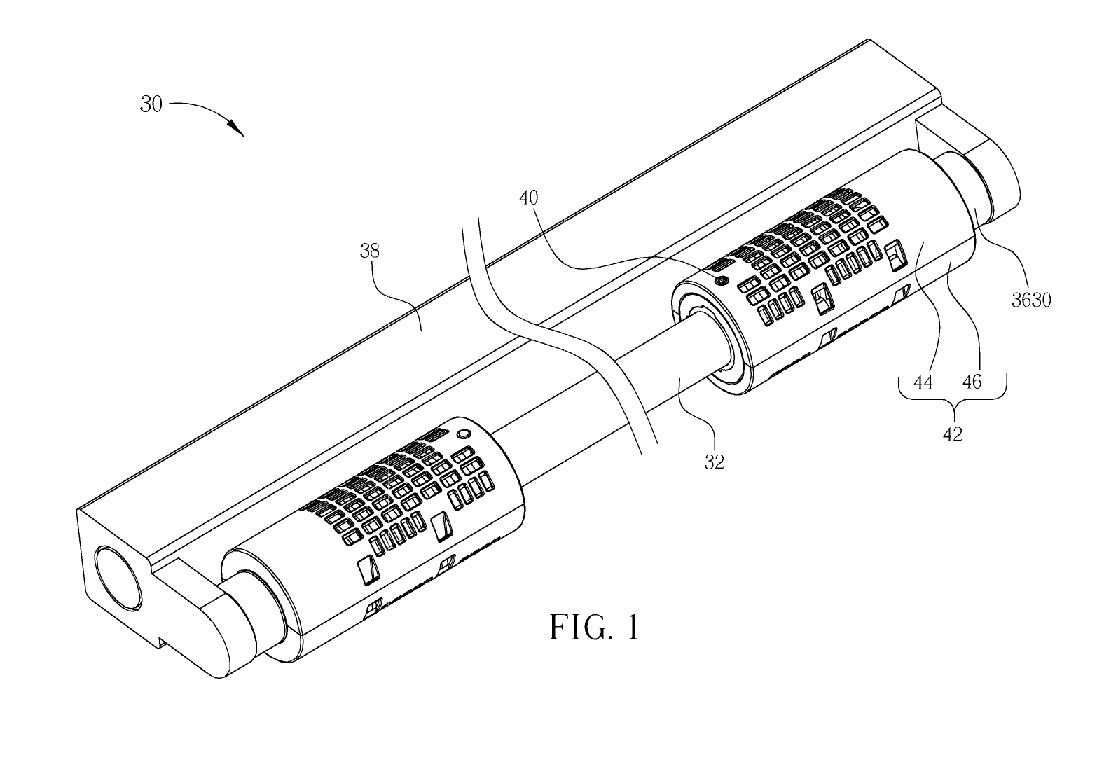

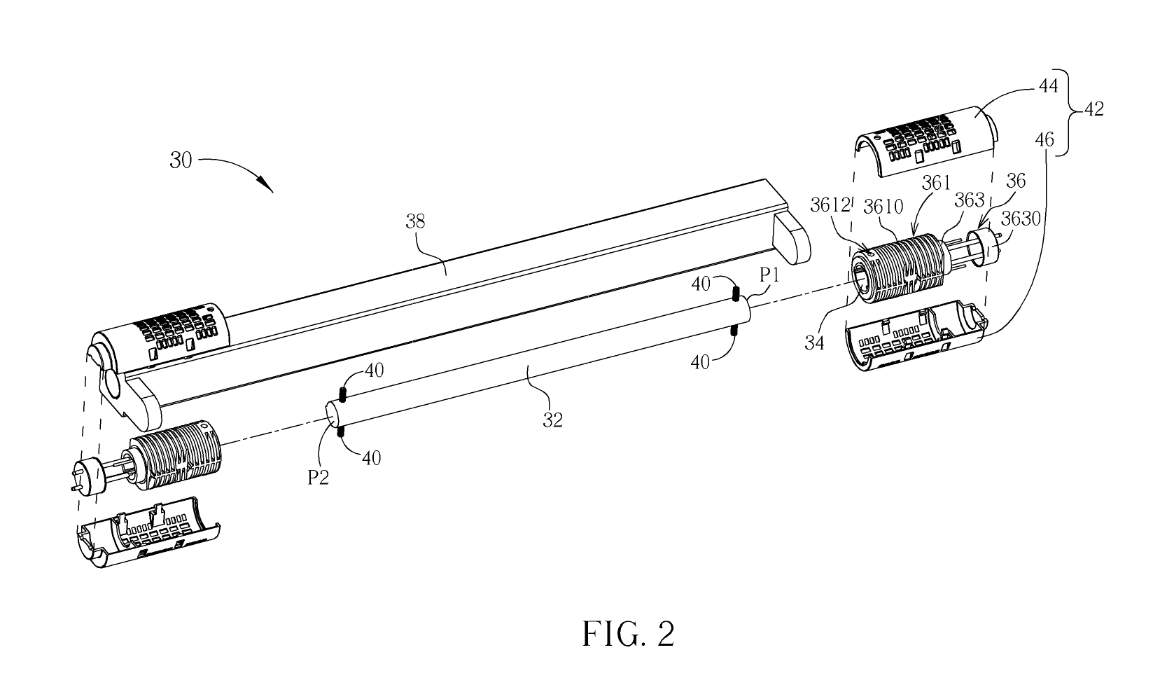

Please refer to FIG. 1 and FIG. 2. FIG. 1 is a diagram of a lamp module 30 according to an embodiment of the present invention. FIG. 2 is an exploded diagram of the lamp module 30 according to the embodiment of the present invention. As shown in FIG. 1 and FIG. 2, the lamp module 30 includes a light guide member 32 and at least one light emitting unit 34. The light guide member 32 has a first end P1 and a second end P2 opposite to the first end P1. In this embodiment, there are two light emitting units 34, and the two light emitting units 34 can be disposed on the first end P1 and the second end P2 of the light guide member 32, respectively. It should be noticed that the number of light emitting unit 34 is not limited to that mentioned in this embodiment. For example, the lamp module 30 can also have one single light emitting unit 34 being disposed on an end, i. e. either the first end P1 or the second end P2, of the light guide member 32.

Practically, the light emitting unit 34 is adapted for emitting lights when the lamp module 30 illuminates, and the light guide member 32 is adapted for guiding the lights emitted from the light emitting unit 34 to project out of the lamp module 30 precisely. In this embodiment, the light emitting unit 34 can be a light emitting diode (LED), and the light guide member 32 can be made of transparent materials, such as polycarbonate (PC), polymethyl methacrylate (PMMA), polyethylene terephthalate (PET) and so on.

In addition, the lamp module 30 further includes at least one lamp base assembly 36. In this embodiment, the lamp module 30 can include two lamp head assemblies 36. The lamp base assembly 36 is coupled to the light emitting unit 34 and includes a heat dissipating member 361 and a driving module 363. The heat dissipating member 361 can be attached to the light emitting unit 34 by heat dissipating grease. The heat dissipating member 361 is adapted for dissipating heat generated by the light emitting unit 34 when the light emitting unit 34 emits the lights.

Furthermore, the lamp module 30 can further include a plurality of screwing components 40, i.e., four screwing components 40 are exemplarily used in FIG. 2 and a plurality of screwing holes 3612 is formed on the heat dissipating member 361. The screwing holes 3612 correspond to the screwing components 40, respectively. Each of the screwing components 40 passes through the corresponding screwing hole 361 2 to abut against an outer surface of the light guide member 32 when the light guide member 32 is inserted into the heat dissipating member 361 of the lamp base assembly 36, so as to fix the light guide member 32 and the heat dissipating member 361.

Practically, a plurality of heat sink fins 3610 is formed on a surface of the heat dissipating member 361. The heat sink fins 3610 are adapted to increase heat dissipating area of the heat dissipating member 361, so as to enhance heat dissipating effect of the heat dissipating member 361. The driving module 363 is coupled to the light emitting unit 34 for driving the light emitting unit 34 to illuminate. Furthermore, the driving module 363 has a connecting socket 3630, and the lamp module 30 further includes a lamp holder 38. The connecting socket 3630 is adapted for being connected to the lamp holder 38, so as to further couple the lamp module 30 to an external power source, which is not shown in the figures. In such way, the light emitting unit 34 of the present invention can be powered by the external power source from the lamp holder 38. The lamp holder 38 can be, but not limited to, a conventional T5 lamp holder. For example, the lamp holder 38 can also be a T8 lamp holder as well. As for which one of the above-mentioned designs is adopted, it depends on practical demands.

Additionally, the lamp module 30 further includes at least one protective cover 42. In this embodiment, two protective covers 42 are used to correspond to each of the lamp heat assemblies 36. The number of protective cover 42 used, however, is not limited to what is mentioned in this embodiment, and it depends on practical demands. The protective cover 42 is adapted for covering or containing the lamp base assembly 36 of the lamp module 30, so as to facilitate the lamp module 30 to be installed and to prevent a user from touching the lamp base assembly 36.

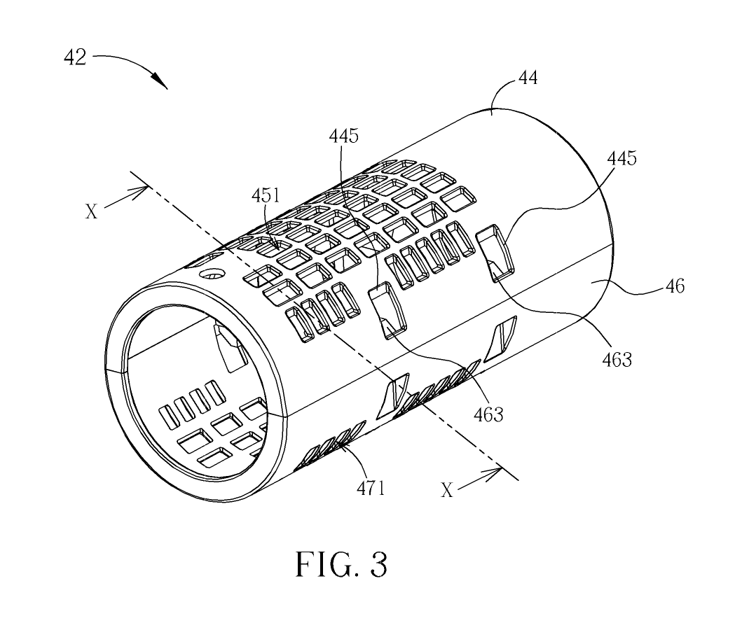

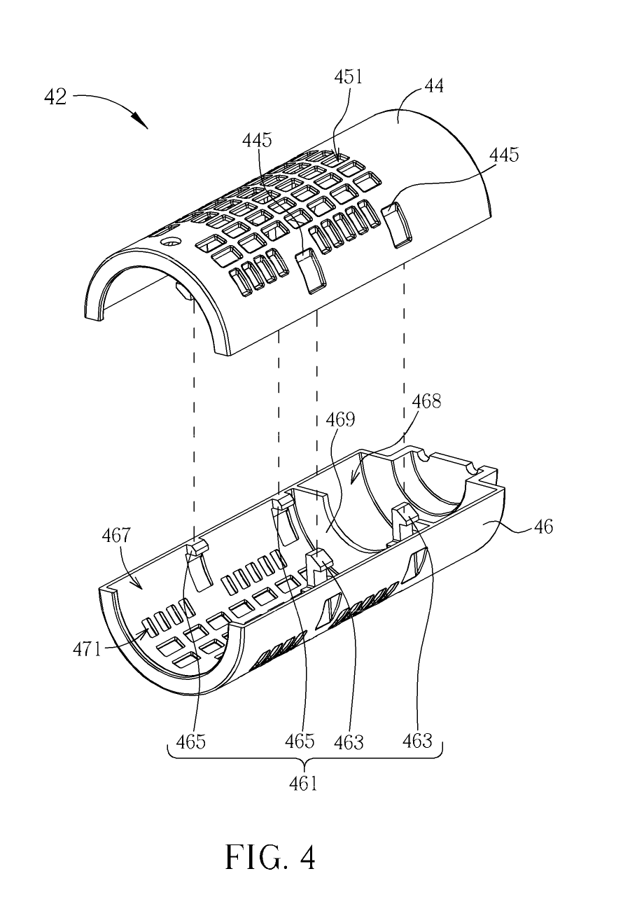

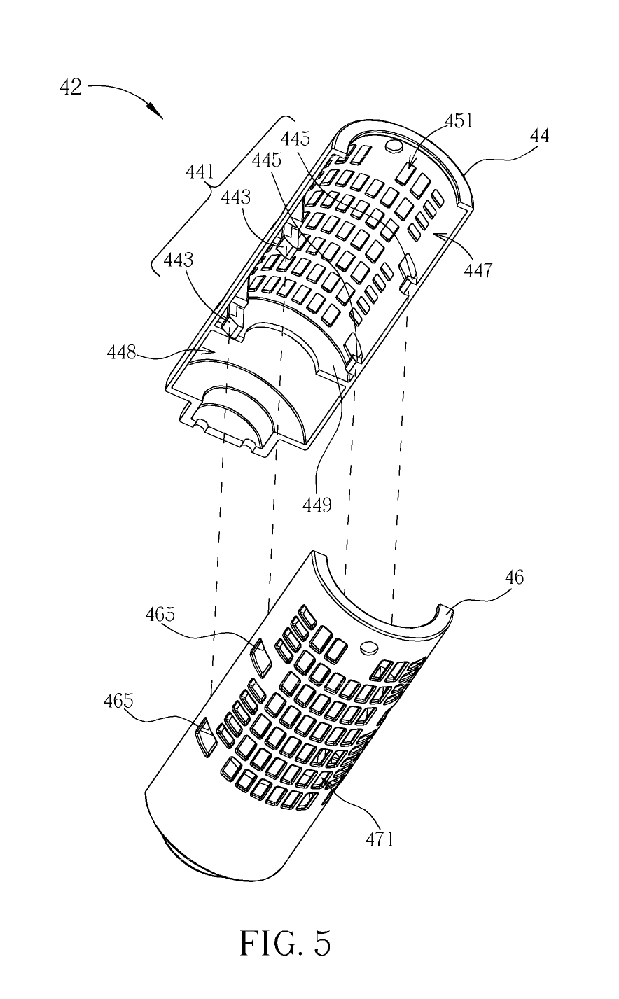

Please refer to FIG. 3 to FIG. 5. FIG. 3 is a diagram of the protective cover 42 according to the embodiment of the present invention. FIG. 4 is an exploded diagram of the protective cover 42 in FIG. 3. FIG. 5 is an exploded diagram of the protective cover 42 in FIG. 4 in another view. As shown in FIG. 3 to FIG. 5, the protective cover 42 includes a first housing 44 and a second housing 46. The first housing 44 includes a first engaging portion 441, and the second housing 46 includes a second engaging portion 461 corresponding to the first engaging portion 441. Furthermore, the first engaging portion 441 includes at least one first hook 443 and at least one first slot 445, and the second engaging portion 461 includes at least one second hook 463 and at least one second slot 465. In this embodiment, there are two first hooks 443, two first slots 445, two second hooks 463 and two second slots 465. The first hooks 443 respectively correspond to the second slots 465, and the second hooks 463 respectively correspond to the first slots 445. In other words, each of the first hooks 443 is used for engaging with the corresponding second slot 465, and each of the second hooks 463 is used for engaging with the corresponding first slot 445, so that the first housing 44 and the second housing 46 may be assembled for the protective cover 42 to contain the lamp base assembly 36.

The first housing 44 further includes a first heat dissipating chamber 447 and a first containing chamber 448 communicating with the first heat dissipating chamber 447. The first housing 44 can further include a first rib 449 for dividing the first housing 44 into the first heat dissipating chamber 447 and the first containing chamber 448. The second housing 46 further includes a second heat dissipating chamber 467 and a second containing chamber 468 communicating with the second heat dissipating chamber 467. The second housing 46 can further include a second rib 469 for dividing the second housing 46 into the second heat dissipating chamber 467 and the second containing chamber 468. When the first housing 44 is assembled with the second housing 46, the first hook 443 of the first housing 44 and the second hook 463 of the second housing 46 engage with the second slot 465 of the second housing 46 and the first slot 445 of the first housing 44, respectively. Accordingly, the first heat dissipating chamber 447 of the first housing 44 and the second heat dissipating chamber 467 of the second housing 46 cooperatively contain the heat dissipating member 361 of the lamp base assembly 36, and the first containing chamber 448 of the first housing 44 and the second containing chamber 468 of the second housing 46 cooperatively contain the driving module 363 of the lamp base assembly 36.

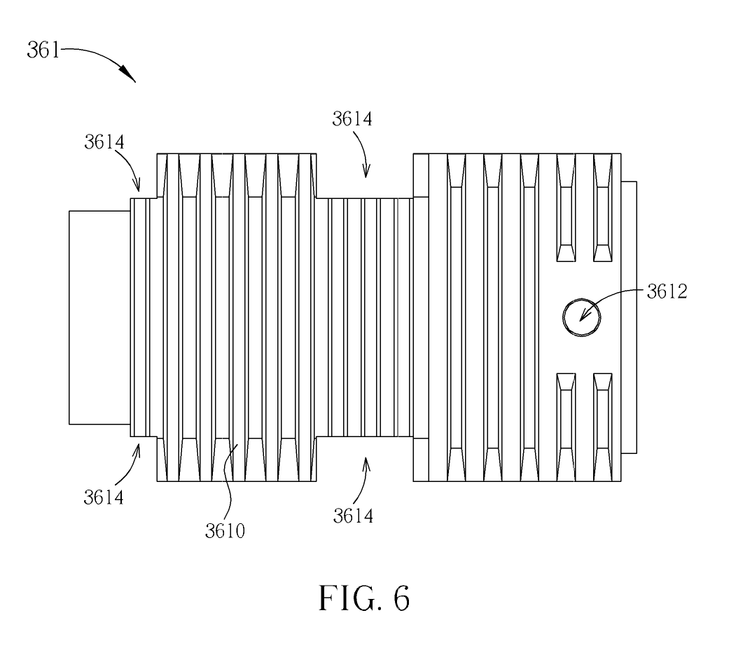

Please refer to FIG. 6. FIG. 6 is a top view of the heat dissipating member 361 according to the embodiment of the present invention. As shown in FIG. 6, a plurality of breaches 3614 is formed on the heat dissipating member 361. In this embodiment, there are four breaches 3614, and each of the breaches 3614 corresponds to the first hook 443 of the first engaging portion 441 and the second hook 463 of the second engaging portion 461. Spaces formed by the breaches 3614 allow the first hook 443 of the first engaging portion 441 to pass through, such that the first hook 443 of the first engaging portion 441 engages with the second slot 465 of the second engaging portion 461 through the corresponding breach 3614, and further allow the second hook 463 of the second engaging portion 461 to pass through, such that the second hook 463 of the second engaging portion 461 engages with the first slot 445 of the first engaging portion 441 through the corresponding breach 3614. In summary, the breaches 3614 of the heat dissipating member 361 of the present invention allow the first engaging portion 441 of the first housing 44 and the second engaging portion 461 of the second housing 46 to pass through, such that the second engaging portion 461 engages with the first engaging portion 441. In such way, the first housing 44 can combine with the second housing 46, such that the first heat dissipating chamber 447 and the second heat dissipating chamber 467 cooperatively contain the heat dissipating member 361 of the lamp base assembly 36.

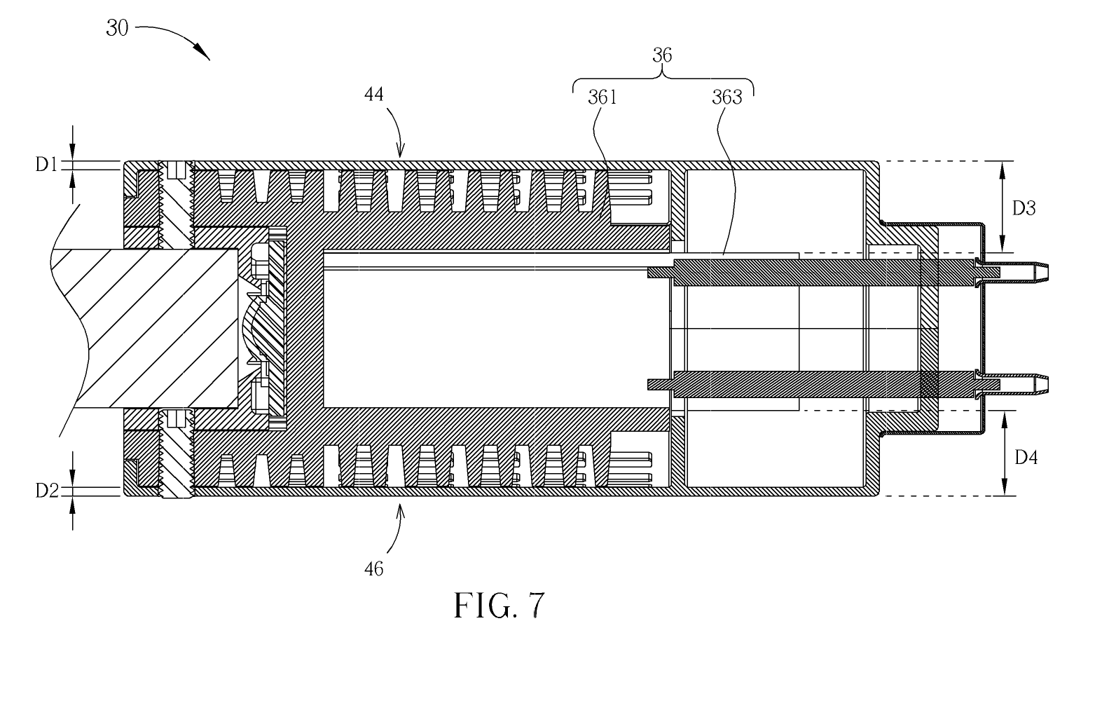

Please refer to FIG. 7. FIG. 7 is a partly sectional diagram of the lamp module 30 according to the embodiment of the present invention. As shown in FIG. 7, when the first housing 44 and the second housing 46 cooperatively contain the lamp base assembly 36, a surface of the heat dissipating member 361 of the lamp base assembly 36 is separated from a surface of the first housing 44 of the protective cover 42 and a surface of the second housing 46 of the protective cover 42 by a distance D1, D2 respectively and a surface of the driving module 363 of the lamp base assembly 36 is separated from the surface of the first housing 44 of the protective cover 42 and the surface of the second housing 46 of the protective cover 42 by a distance D3, D4 respectively. When the protective cover 42 covers the lamp base assembly 36, the user is incapable of touching the heated surfaces of the lamp base assembly 36 directly. Accordingly, the protective cover 42 of the present invention can prevent the user from getting burned by the heated surfaces of the lamp base assembly 36. In this embodiment, the protective cover 42 of the present invention can be made in materials with low coefficient of thermal conductivity, such as plastic materials. In such way, heat generated by the heated surfaces of the lamp base assembly 36 may not be easily conducted to the first housing 44 and the second housing 46 of the protective cover 42, so as to achieve heat proof effect. It should be noticed that the heat dissipating member 361 can be separated from, instead of contacting, the first housing 44 and the second housing 46 of the protective cover 42.

Please refer to FIG. 3 to FIG. 5, a plurality of first through holes 451 and a plurality of second through holes 471 are respectively formed on the first housing 44 and the second housing 46. When the first housing 44 and the second housing 46 cooperatively cover the lamp base assembly 36, the first through holes 451 and the second through holes 471 allow air to flow through the protective cover 42. Accordingly, the heat generated by the lamp base assembly 36 is dissipated out of the protective cover 42 via the heat dissipating member 361, the first through holes 451 and the second through holes 471, so as to lower the temperature of the surfaces of the first housing 44 and the second housing 46. Practically, in order to prevent the user from touching the heated surfaces of the lamp base assembly 36 via the first through holes 451 and the second through holes 471, each opening area of the first through holes 451 is preferably not greater than 4 square millimeters, and each opening area of the second through holes 471 is preferably not greater than 4 square millimeters either. When each of the first through holes 451 and each of the second through holes 471 has opening areas with smaller size, i.e. smaller than sizes of the user's fingers, the protective cover 42 of the present invention effectively prevents the user from touching the heated surfaces of the heat dissipating member 361 through the first through holes 451 and the second through holes 471, which therefore reduces the risks of getting burned.

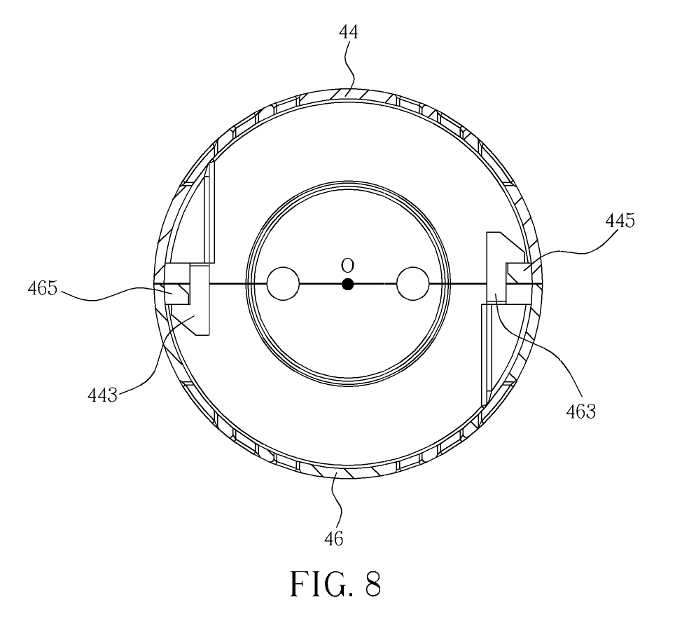

Please refer to FIG. 8. FIG. 8 is a sectional diagram of the protective cover 42 taken along a section line X-X shown in FIG. 3. As shown in FIG. 8, when the second hook 463 and the second slot 465 of the second housing 46 rotates about an axis 0 by 180 degrees, the second hook 463 and the second slot 465 of the second housing 46 overlap with the first hook 443 and the first slot 445 of the first housing 44. In other words, the first housing 44 is identical to the second housing 46 in this embodiment. Practically, the first housing 44 and the second housing 46 can be molded by the same mold for saving costs in manufacture, resulting in that prices of the products can be more advantageous in the market.

Compared to the prior art, the present invention utilizes the first housing and the second housing to cooperatively cover the lamp base assembly, so as to contain the exposed components of the lamp base assembly. Accordingly, it can facilitate assembly process of a lamp holder. The protective cover can be detached in advance for a lamp of the lamp module to be installed inside the lamp holder, so as to facilitate assembly process. As a result, the detachable protective cover can meet user's requirements depending on practical demands, such that the lamp module is capable of being installed onto various lamp holders conveniently. Furthermore, the surface of the lamp base assembly is respectively separated from the surface of the first housing and the surface of the second housing by the distance, so as to prevent the user from touching the lamp base assembly directly. As a result, the present invention can prevent the user from getting burned by preventing the user from touching the lamp base assembly directly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A protective cover for covering a lamp base assembly of a lamp module, the lamp base assembly adapted for actuating the lamp module, the protective cover comprising:
a first housing comprising a first engaging portion; and
a second housing comprising a second engaging portion corresponding to the first engaging portion, the first housing containing the lamp base assembly cooperatively with the second housing and a surface of the lamp base assembly being respectively separated from a surface of the first housing and a surface of the second housing by a distance when the second engaging portion engages with the first engaging portion.

2. The protective cover of claim 1, wherein the first engaging portion comprises at least one first hook and at least one first slot, the second engaging portion comprises at least one second hook and at least one second slot, the at least one first hook is adapted for engaging the at least one second slot, the at least one second hook is adapted for engaging the at least one first slot.

3. The protective cover of claim 2, wherein the first housing is identical to the second housing.

4. The protective cover of claim 2, wherein the first housing and the second housing are molded by the same mold.

5. The protective cover of claim 1, wherein the first housing further comprises a first heat dissipating chamber and a first containing chamber communicating with the first heat dissipating chamber, the second housing further comprises a second heat dissipating chamber and a second containing chamber communicating with the second heat dissipating chamber, the first heat dissipating chamber contains a heat dissipating member of the lamp base assembly cooperatively with the second heat dissipating chamber and the first containing chamber contains a driving module of the lamp base assembly cooperatively with the second containing chamber when the second engaging portion engages with the first engaging portion.

6. The protective cover of claim 1, wherein a plurality of first through holes and a plurality of second through holes are respectively formed on the first housing and the second housing, and heat generated by the lamp base assembly is dissipated out of the protective cover via the plurality of first through holes and the plurality of second through holes.

7. A lamp module, comprising:
a light guide member having a first end and a second end opposite to the first end;
a light emitting unit disposed on at least one of the first end and the second end of the light guide member;
a lamp base assembly coupled to the light emitting unit and adapted for actuating the light emitting unit to illuminate; and
a protective cover, comprising:
a first housing comprising a first engaging portion; and
a second housing comprising a second engaging portion corresponding to the first engaging portion, the first housing containing the lamp base assembly cooperatively with the second housing and a surface of the lamp base assembly being respectively separated from a surface of the first housing and a surface of the second housing by a distance when the second engaging portion engages with the first engaging portion.

8. The lamp module of claim 7, wherein the first engaging portion comprises at least one first hook and at least one first slot, the second engaging portion comprises at least one second hook and at least one second slot, the at least one first hook is adapted for engaging the at least one second slot, the at least one second hook is adapted for engaging the at least one first slot.

9. The lamp module of claim 8, wherein the first housing is identical to the second housing.

10. The lamp module of claim 8, wherein the first housing and the second housing are molded by the same mold.

11. The lamp module of claim 7, wherein the first housing further comprises a first heat dissipating chamber and a first containing chamber communicating with the first heat dissipating chamber, the second housing further comprises a second heat dissipating chamber and a second containing chamber communicating with the second heat dissipating chamber, and the lamp base assembly comprises:
a heat dissipating member connected to the light emitting unit; and
a driving module coupled to the light emitting unit, the first heat dissipating chamber containing the heat dissipating member cooperatively with the second heat dissipating chamber and the first containing chamber containing the driving module cooperatively with the second containing chamber when the second engaging portion engages with the first engaging portion.

12. The lamp module of claim 11, wherein a plurality of breaches is formed on the heat dissipating member corresponding to the first engaging portion and the second engaging portion for allowing the first engaging portion and the second engaging portion to pass through, such that the second engaging portion engages with the first engaging portion.

13. The lamp module of claim 11, wherein the first housing comprises a first rib for dividing the first housing into the first heat dissipating chamber and the first containing chamber, and the second housing comprises a second rib for dividing the second housing into the second heat dissipating chamber and the second containing chamber.

14. The lamp module of claim 11, wherein a plurality of heat sink fins are formed on a surface of the heat dissipating member.
